(19) United States
(12) Patent Application Publication
(10) Pub. No.: US 2020/0384677 A1
(43) Pub. Date: Dec. 10, 2020

(54) COEXTRUDED POLYMERIC ARTICLE AND METHOD OF MAKING THE SAME

(71) Applicant: 3M INNOVATIVE PROPERTIES COMPANY, St. Paul, MN (US)

(72) Inventors: Ronald W. Ausen, St. Paul, MN (US); Thomas P. Hanschen, Mendota Heights, MN (US); William J. Kopecky, Hudson, WI (US); Vasav Sahni, St. Paul, MN (US); Ramasubramani` Kuduva Raman Thanumoorthy, Woodbury, MN (US)

(21) Appl. No.: 16/961,853

(22) PCT Filed: Jan. 14, 2019
(86) PCT No.: PCT/IB2019/050278

§ 371 Date: Jul. 13, 2020

Related U.S. Application Data
(60) Provisional application No. 62/618,261, filed on Jan. 17, 2018.
(60) Provisional application No. 62/632,121, filed on Feb. 19, 2018.

(51) Int. Cl. B29C 48/18; A47L 13/16; B29C 48/07; B29C 48/305; B29C 48/345; B32B 3/08; B32B 27/08

(52) U.S. Cl. CPC B29C 48/18; A47L 13/16; B29C 48/07; B29L 2007/002; B29C 48/345; B32B 3/08; B32B 27/08; B29C 48/307

(57) ABSTRACT

Coextruded polymeric article (100, 200) comprising first and second opposed major surfaces (111, 211), wherein a plurality of projections (114, 117, 214, 214, 217) extend from only the first major surface (111, 112, 211, 212), wherein each projection (214) has at least first and second opposed sides (218) and a height from the first major surface (111, 112, 211, 212) to a distal end (116, 216), wherein at least a majority by number of the projections (114, 117, 214, 214, 217) have a protrusion (117, 217) extending from It only the first side (118, 218) and extending in one direction not more than to the first major surface (111, 112, 211, 212) and extending in an opposite direction to less than the height of the respective projection (214), wherein the projections (114, 117, 214, 214, 217) extend to the second major surface (111, 112, 211, 212), wherein there are regions (119, 120, 220) extending from the first and second major surfaces (111, 211) that are between projections (114, 117, 214, 214, 217), wherein the regions (119, 120, 220) comprise a first material, the projections (114, 117, 214, 214, 217) comprise a second material, and the protrusions (117, 217) comprise a third material, wherein the second and third materials are different, and wherein at least one of the second or third materials comprise adhesives. Uses for coextruded polymeric articles described herein include adhesive articles and household cleaning products (e.g., a mop, a duster, a brush, a cleaning cloth, or a lint roller).

### CROSS REFERENCE TO RELATED APPLICATIONS

This application claims the benefit of U.S. Provisional Patent Application Nos. 62/618261, filed Jan. 17, 2018 and 62/632121, filed Feb. 19, 2018, the disclosures of which are incorporated by reference herein in their entireties.

### BACKGROUND

Coextruded polymeric articles (including layers) having projections are known in the art. For example, it is known to provide a co-extruded, layer structures where the layer is partitioned, not as coextensive layers in the thickness direction, but as stripes or strands along the width dimension of the layer. This has sometimes been called “side-by-side” co-extrusion.

There is a desire for additional polymeric articles with projections that offer different configurations and/or properties (e.g., adhesive properties) over conventional articles. Some adhesive systems that switch from a state of relatively low or no adhesion to a state of much higher adhesion upon application of a certain trigger (commonly called “adhesion on demand” systems) are known. Many of these systems use triggers such as solvents, ultra violet light, heat, or magnetic forces, to create tiered adhesive performance once or repetitively. These systems are limited in applications for several reasons. For many of these triggers, the adhesive system must contain specific chemical groups, which restricts usage to applications where those chemical groups can be tolerated. These systems can be used only where a particular trigger is available and can be effectively applied to the adhesive system. Further, some triggers are difficult or inconvenient for consumers to use. Certain triggers, as well as the chemical groups in the adhesive that respond to such triggers, can be cost-prohibitive.

There is a need for “adhesion on demand” systems where the trigger is applicable to all adhesive chemistries, the trigger is more broadly or even universally available, the trigger is easy to apply, not only industrially, but by a consumer, and the adhesion-on-demand system is not exceedingly expensive.

### SUMMARY

In one aspect, the present disclosure describes a first coextruded polymeric article comprising first and second opposed major surfaces, wherein a plurality of projections extend from only the first major surface (i.e., the second major surface is free of any projections), wherein each projection has at least first and second opposed sides and a height from the first major surface to a distal end, wherein at least a majority by number (i.e., at least 50 percent by number; in some embodiments, at least 55, 60, 65, 70, 75, 80, 85, 90, 95, or even 100 percent) of the projections have a protrusion extending from only the first side and extending in one direction not more than to the first major surface and extending in an opposite direction to less than the height of the respective projection (i.e., less than to the distal end of the respective protrusion), wherein the projections extend to the second major surface, wherein there are regions extending between the first and second major surfaces that are between projections, wherein the regions comprise a first material, the projections comprise a second material, and the protrusions comprise a third material, wherein the second and third materials are different, and wherein at least one of the second or third materials comprise adhesive. “Different” as used herein means at least one of (a) a difference of at least 2% in at least one infrared peak, (b) a difference of at least 2% in at least one nuclear magnetic resonance peak, (c) a difference of at least 2% in the number average molecular weight, or (d) a difference of at least 5% in polydispersity. Examples of differences in polymeric materials that can provide the difference between polymeric materials include composition, microstructure, color, and refractive index. The term “same” in terms of polymeric materials means not different.

In some embodiments, connected projections and adjacent protrusions have a demarcation line therebetween. This construction can be formed by methods described herein where materials are coextruded in a manner that results in a distinct line of orientation visible at the polymer boundary between connected projections and protrusions. This demarcation line or boundary region between connected projections and protrusions can be detected using Differential Scanning calorimetry. Comparing by temperature modulated differential scanning calorimetry a region containing mostly a demarcation line (Region 1) versus a region that does not substantially contain material from the demarcation line (Region 2) a difference in heat flow/heat capacity is observed that is believed to be consistent with an energy release or reduction in molecular orientation/internal stress. That is, although not wanting to be bound by theory, it is believed that the thermal signatures of the regions may be a combination of material thermal transitions and the material response to retained thermal/processing history. In some embodiments, there is a demarcation line between connected regions and projections.

In another aspect, the present disclosure describes a first method for making the first coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;

extruding a layer from the distal opening of the die slot; and

quenching the extruded layer.

In another aspect, the present disclosure describes a second method for making the first coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;

extruding a layer from the distal opening of the die slot; and

quenching the extruded layer.

In another aspect, the present disclosure describes a second coextruded polymeric article comprising first and second opposed major surfaces, wherein a plurality of projections extend from only the first major surface (i.e., the second major surface is free of any projections), wherein each projection has at least first and second opposed sides and a height from the first major surface to a distal end, wherein at least a majority by number (i.e., at least 50 percent by number; in some embodiments, at least 55, 60, 65, 70, 75, 80, 85, 90, 95, or even 100 percent) of the projections have a protrusion extending from only the first side and extending in one direction not more than to the first major surface and extending in an opposite direction to less than the height of the respective projection (i.e., less than to the distal end of the respective protrusion), wherein the projections extend to the second major surface, wherein there are regions extending between the first and second major surfaces that are between projections, wherein the regions comprise a first material, the projections comprise a second material, and the protrusions comprise a third material, wherein at least two of the first, second, or third materials are different, and wherein the first, second, or third materials each comprise an adhesive.

In another aspect, the present disclosure describes a first method for making the second coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;

extruding a layer from the distal opening of the die slot; and

quenching the extruded layer.

In another aspect, the present disclosure describes a second method for making the second coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;

extruding a layer from the distal opening of the die slot; and

quenching the extruded layer.

Embodiments of coextruded polymeric articles described herein can include adhesive articles, household cleaning products (e.g., a mop, a duster, a brush, a cleaning cloth, or a lint roller), and wall attachments.

Embodiments of coextruded polymeric articles described herein can provide a tiered performance, such that for some property of merit (e.g., an adhesive level), the coextruded polymeric article exhibits one level of or value for that property in a base condition or state of use, and at least one different level of or value for that property when in at least one triggered condition or state of use.

### BRIEF DESCRIPTION OF THE DRAWINGS

FIG. 1 is a schematic cross-sectional view of an exemplary coextruded polymeric article described herein.

FIG. 2 is a schematic cross-sectional view of another exemplary coextruded polymeric article described herein.

FIG. 3 is a schematic cross-sectional view of an exemplary die cavity pattern just upstream from the dispensing slot of the die employed in the formation of an exemplary coextruded polymeric article described herein.

FIG. 4 is a schematic cross-sectional view of another exemplary die cavity pattern just upstream from the dispensing slot of the die employed in the formation of an exemplary coextruded polymeric article described herein.

FIG. 5A is a plan view of an exemplary embodiment of a shim suited to form a sequence of shims capable of forming an exemplary coextruded polymeric article, for example, as shown in the schematic cross-sectional views of FIGS. 1 and 2.

FIG. 5B is an expanded region near the dispensing surface of the shim shown in FIG. 5A.

FIG. 6A is a plan view of an exemplary embodiment of a shim suited to form a sequence of shims capable of forming a coextruded polymeric article, for example, as shown in the schematic cross-sectional views of FIGS. 1 and 2.

FIG. 6B is an expanded region near the dispensing surface of the shim shown in FIG. 6A.

FIG. 7A is a plan view of an exemplary embodiment of a shim suited to form a sequence of shims capable of forming a coextruded polymeric article, for example, as shown in the schematic cross-sectional views of FIGS. 1 and 2.

FIG. 7B is an expanded region near the dispensing surface of the shim shown in FIG. 7A.

FIG. 8A is a plan view of an exemplary embodiment of a shim suited to form a sequence of shims capable of forming a coextruded polymeric article, for example, as shown in the schematic cross-sectional views of FIGS. 1 and 2.

FIG. 8B is an expanded region near the dispensing surface of the shim shown in FIG. 8A.

FIG. 9A is a plan view of an exemplary embodiment of a shim suited to form a sequence of shims capable of forming a coextruded polymeric article, for example, as shown in the schematic cross-sectional views of FIGS. 1 and 2.

FIG. 9B is an expanded region near the dispensing surface of the shim shown in FIG. 9A.

FIG. 10 is a perspective assembly drawing of several different exemplary sequences of shims employing the shims of FIGS. 5A-9A for making exemplary coextruded polymeric articles described herein, including regions, projections, and protrusions in a repeating arrangement as shown in FIGS. 1 and 2.

FIG. 11 is a perspective view of the some of the sequence of shims of FIG. 10, further exploded to reveal some individual shims.

FIG. 12A is a plan view of an embodiment of a shim suited to form an exemplary sequence of shims capable of forming a coextruded polymeric article, for example, as shown in the schematic cross-sectional views of FIGS. 1 and 2, and using a die orifice pattern as shown in FIG. 4.

FIG. 12B is an expanded region near the dispensing surface of the shim shown in FIG. 12A.

FIG. 13 is an exploded perspective view of an example of a mount suitable for an extrusion die composed of multiple repeats of the sequence of shims of FIGS. 10 and 11.

FIG. 14 is a perspective view of the mount of FIG. 13 in an assembled state.

FIG. 15 is an optical image of the Example 1 article.

### DETAILED DESCRIPTION

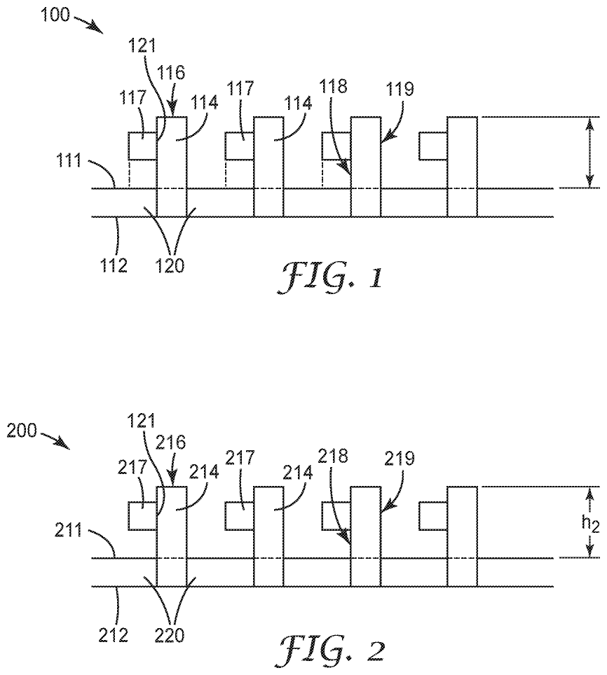

Referring to FIG. 1, exemplary first coextruded polymeric article 100 has first and second opposed major surfaces 111, 112. Plurality of projections 114 extend from only first major surface 111 (i.e., not from second major surface 112) and have height h₁ from first major surface 111 to distal end 116. At least a majority by number (i.e., at least 50 percent by number; in some embodiments, at least 55, 60, 65, 70, 75, 80, 85, 90, 95, or even 100 percent) of projections 114 have a protrusion 117 extending from only first side 118 and extend in one direction not more than to first major surface 111 and extend in an opposite direction to less than the height of the respective projection (i.e., less than to the distal end of the respective protrusion). Projections 114 extend to second major surface 112. Regions 119 extending between first and second major surfaces 111, 112 that are between projections 114. Regions 120 comprise a first material. Projections 117 comprises a second material. Protrusions comprise a third material. Second and third materials are different. At one least one of the second or third materials comprise adhesives. As shown, there is demarcation line 121 between connected projections 114 and protrusions 117. Although not shown, in some embodiments, there is a demarcation line between connected regions (119) and projections (114). Distance, di, measured from the respective midpoints of two projections, is used to express the number of projections in a given distance. Distance, d₂, which is measured from the closest sides of two projections, is used to express the distance between projections.

In some embodiments, at least one of the first, second, or third materials of the first coextruded polymeric article described herein independently comprise at least one of a thermoplastic resin (e.g., at least one of, including copolymers and blends thereof, a polyolefin (e.g., polypropylene and polyethylene), polyvinyl chloride, a polystyrene, nylon, a polyester (e.g., polyethylene terephthalate) or an elastomer (e.g., an ABA block copolymer, a polyurethane, a polyolefin elastomer, a polyurethane elastomer, a metallocene polyolefin elastomer, a polyamide elastomer, an ethylene vinyl acetate elastomer, and a polyester elastomer)). In some embodiments, at least one of the first, second, or third materials of the first coextruded polymeric article described herein independently comprise an adhesive. In some embodiments, at least one of the first, second, or third adhesives of the first coextruded polymeric article described herein are independently at least one of, including copolymers and blends thereof, an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.

In some embodiments, the first and second materials of the first coextruded polymeric article described herein are the same. In some embodiments, the first and second materials of the first coextruded polymeric article described herein are different. In some embodiments, the first and third materials of the first coextruded polymeric article described herein are the same.

Referring to FIG. 2, exemplary second coextruded polymeric article 200 has first and second opposed major surfaces 211, 212. Plurality of projections 214 extend from only first major surface 212 (i.e., second major surface 212 is free of any projections). Each projection 214 has at least first and second opposed sides 218, 219 and height h₂ from first major surface 211 to a distal end 216. At least a majority by number (i.e., at least 50 percent by number; in some embodiments, at least 55, 60, 65, 70, 75, 80, 85, 90, 95, or even 100 percent) of projections 214 have protrusion 217 extending from only first side 218 and extending in one direction not more than to first major surface 211 and extending in an opposite direction to less than the height of the respective projection (i.e., less than to the distal end of the respective protrusion). Projections 214 extend to second major surface 212. Regions 220 extending from first and second major surfaces 211, 212 that are between projections 214. Regions 220 comprise a first material. Projections 217 comprise a second material. Protrusions 217 comprise a third material. At least two of the first, second, or third materials are different. The first, second, and third materials each comprise an adhesive. As shown, there is demarcation line 221 between connected projections 214 and protrusions 217. Although not shown, in some embodiments, there is a demarcation line between connected regions (219) and projections (214). Distance, d₃, measured from the respective midpoints of two projections, is used to express the number of projections in a given distance. Distance, d₄, which is measured from the closest sides of two projections, is used to express the distance between projections.

In some embodiments, the first and second coextruded polymeric articles described herein have a (machine direction) length of at least 5 mm (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m). In some embodiments, the protrusions and projections extend along the length of the coextruded polymeric article (i.e., have respective lengths of at least 5 mm (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m)).

In another aspect, the present disclosure describes a first method for making the first coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive; extruding a layer from the distal opening of the die slot; and quenching the extruded layer.

In another aspect, the present disclosure describes a second method for making the first coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;

extruding a layer from the distal opening of the die slot; and

quenching the extruded layer.

In another aspect, the present disclosure describes a first method for making the second coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;

extruding a layer from the distal opening of the die slot; and

quenching the extruded layer.

In another aspect, the present disclosure describes a second method for making the second coextruded polymeric article described herein, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;

extruding a layer from the distal opening of the die slot; and

quenching the extruded layer.

Coextruded polymeric articles described herein (including those shown in FIGS. 1 and 2), each of the regions, projections, and protrusions may be considered monolithic (i.e., having a generally uniform composition) and are not fibrous. Further, the protrusions and projections are not nonwoven materials, nor are they coated or added via as a secondary step. In some embodiments described below, however, portions of the articles may be apertured. Typically, the projections and protrusions are co-extruded and melt bonded together to form coextruded, continuous, polymeric articles with projections and protrusions.

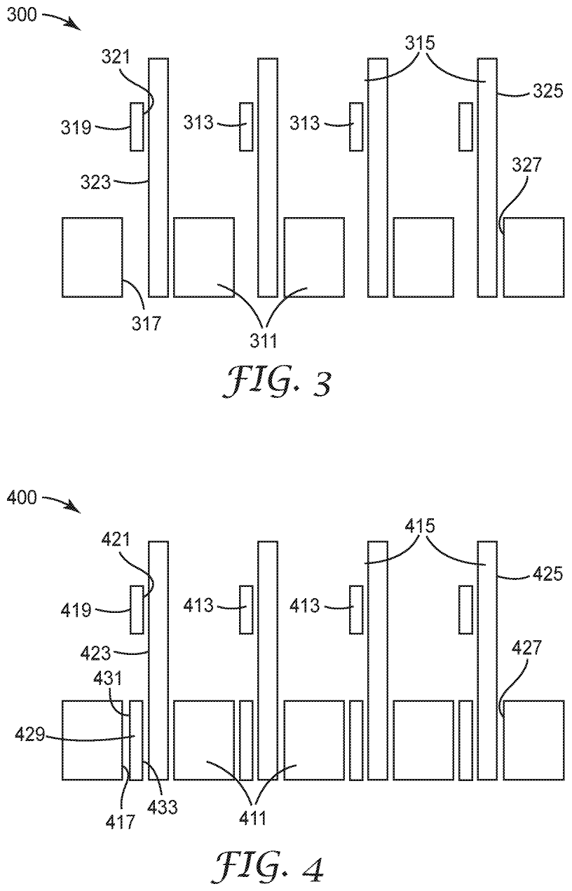

Referring again to FIG. 1, coextruded polymeric article 100 can be prepared, for example, by extrusion from a die having a variety of passageways from cavities within the die to a dispensing slot, including exemplary dies described herein (see, e.g., FIGS. 3 and 4). The die may conveniently be comprised of a plurality of shims. In some embodiments, the plurality of shims comprises a plurality of sequences of shims that includes shims that provide a passageway between a first and second cavity and the dispensing slot. In some of these embodiments, there will be additional shims that provide a passageway between the first and/or the second cavity, and/or a third (or more) cavity and the dispensing slot.

In some embodiments, the shims will be assembled according to a plan that provides a sequence of shims of diverse types. Since different applications may have different requirements, the sequences can have diverse numbers of shims. The sequence may be a repeating sequence that is not limited to a particular number of repeats in a particular zone. Or the sequence may not regularly repeat, but different sequences of shims may be used. The shape of the passageways within, for example, a sequence of shims, may be identical or different. Examples of passageway cross-sectional shapes include round, square, and rectangular shapes. In some embodiments, the shims that provide a passageway between one cavity and the dispensing slot might have a flow restriction compared to the shims that provide a passageway between another cavity and the dispensing slot. The width of the distal opening within, for example, a different sequence of shims, may be identical or different. For example, the portion of the distal opening provided by the shims that provide a passageway between one cavity and the dispensing slot could be narrower than the portion of the distal opening provided by the shims that provide a passageway between another cavity and the dispensing slot.

Individual cavities and passageways provide a conduit for polymer to orifices to create the protrusions, the projections, and the film base region. These individual flowstreams merge together to form a continuous, solid coextruded polymeric article, at the die slot portion of the die. Spacer shims provide connecting slots to form demarcation lines connecting the protrusions, projections and regions.

In some embodiments, extrusion dies described herein include a pair of end blocks for supporting the plurality of shims. In these embodiments, it may be convenient for one, or even all, of the shims to each have at least one through-holes for the passage of connectors between the pair of end blocks. Bolts disposed within such through-holes are one convenient approach for assembling the shims to the end blocks, although the ordinary artisan may perceive other alternatives for assembling the extrusion die. In some embodiments, the at least one end block has an inlet port for introduction of fluid material into one, or both, of the cavities.

In some embodiments, the shims will be assembled according to a plan that provides a repeating sequence of shims of diverse types. The repeating sequence can have diverse numbers of shims per repeat. For a first example, a repeating sequence utilizing 5 shims is described below to create the orifice pattern shown in FIG. 3 to create the coextruded polymeric article shown in FIG. 1. When that five-shim repeating sequence is properly provided with molten polymer, it extrudes a continuous film through the die slot to create the coextruded polymeric article with projections and protrusions.

In some embodiments, the assembled shims (conveniently bolted between the end blocks) further comprise a manifold body for supporting the shims. The manifold body has at least one (e.g., in some embodiments, at least two, three, four, or more) manifold therein, the manifold having an outlet.

An expansion seal (e.g., made of copper or alloys thereof) is disposed to seal the manifold body and the shims, such that the expansion seal defines a portion of at least one of the cavities (in some embodiments, a portion of both the first and second cavities), and such that the expansion seal allows a conduit between the manifold and the cavity.

Typically, the passageway between cavity and dispensing orifice is up to 5 mm in length. Sometimes the fluid passageways leading to one array has greater fluid restriction than the fluid passageways leading to one or more of the other arrays.

The shims for dies described herein typically have thicknesses in the range from 50 micrometers to 125 micrometers, although thicknesses outside of this range may also be useful. Typically, the fluid passageways have thicknesses in a range from 50 micrometers to 750 micrometers, and lengths less than 5 mm (with generally a preference for smaller lengths for decreasingly smaller passageway thicknesses), although thicknesses and lengths outside of these ranges may also be useful. For large diameter fluid passageways, several smaller thickness shims may be stacked together, or single shims of the desired passageway width may be used.

The shims are tightly compressed to prevent gaps between the shims and polymer leakage. For example, 12 mm (0.5 inch) diameter bolts are typically used and tightened, at the extrusion temperature, to their recommended torque rating. Also, the shims are aligned to provide uniform extrusion out the extrusion orifice, as misalignment can lead to strands extruding at an angle out of the die which inhibits desired bonding of the net. To aid in alignment, an alignment key can be cut into the shims. Also, a vibrating table can be useful to provide a smooth surface alignment of the extrusion tip.

In practicing methods described herein, the polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second and/or third polymeric materials are low molecular weight polymers that need to be cross-linked to be solidified, which can be done, for example, by electromagnetic or particle radiation. In some embodiments, it is desirable to maximize the time to quenching to increase the bond strength.

FIG. 3 is a schematic cross-sectional view of an exemplary die orifice pattern just upstream from the dispensing slot of the die employed in the formation of an exemplary coextruded polymeric article described herein. Orifice plan 300 shows first orifices 317, second orifices 323, and third orifices 319. As will be described in detail later, the orifices are spaced apart to provide passageway sidewalls between passageways with the use of spacer shims. The individual flowstreams are merged together, with demarcation lines to form a continuous coextruded polymeric article in the final slot orifice of the die, not shown.

FIG. 4 is a schematic cross-sectional view of another exemplary die orifice pattern just upstream from the dispensing slot of the die employed in the formation of an exemplary coextruded polymeric article described herein. Orifice plan 400 shows first orifices 417, second orifices 423, and third orifices 419. As will be described in detail later, the orifices are spaced apart to provide passageway sidewalls between passageways. The individual flowstreams are merged together, with demarcation lines to form a continuous coextruded polymeric article in the final slot orifice of the die, not shown. The demarcation lines are created at orifices separated by a minimal amount, by spacer shims. These shims typically have thicknesses in a range from 50 to 200 micrometers. The depth of the final slot is long enough, and the distance between the orifices are close, such that a continuous article, a created sum of all orifices, is formed within the final slot of the die.

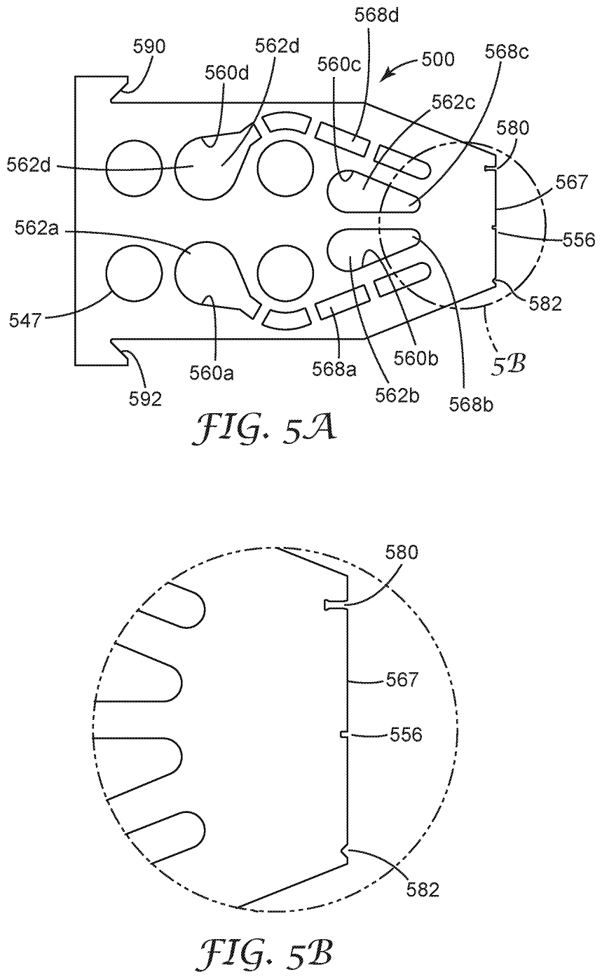

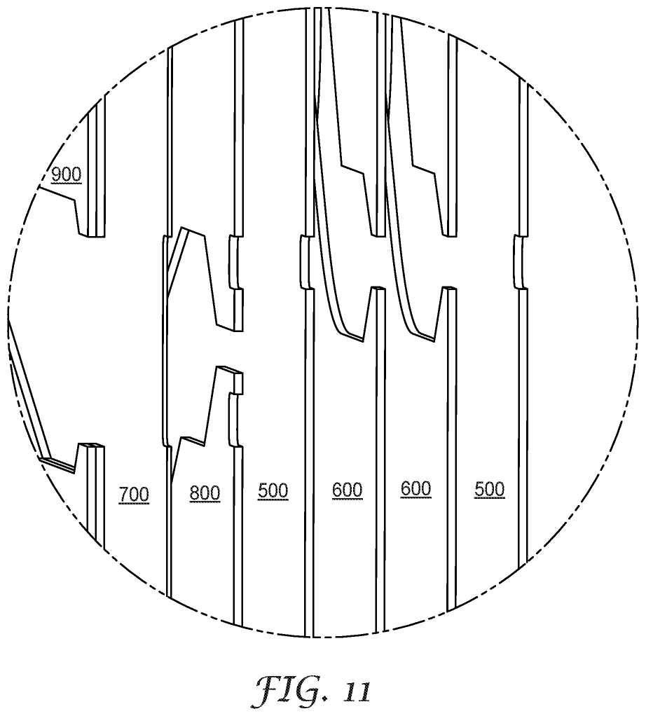

Referring now to FIGS. 5A and 513, a plan view of shim 500 is illustrated. Shim 500 has first aperture 560a, second aperture 560b, third aperture 560c, and fourth aperture 560d. When shim 500 is assembled with others as shown in FIGS. 10 and 11, aperture 560a aids in defining first cavity 562a, aperture 560b aids in defining second cavity 562b, aperture 560c aids in defining third cavity 562e, and aperture 560d aids in defining third cavity 562d. Passageways 568a, 568b, 568c, and 568d cooperate with analogous passageways on adjacent shims to allow passage from cavities 562a, 562b, 562c, and 562d to the dispensing surfaces of the appropriate shims when the shims are assembled as shown in FIGS. 10 and 11.

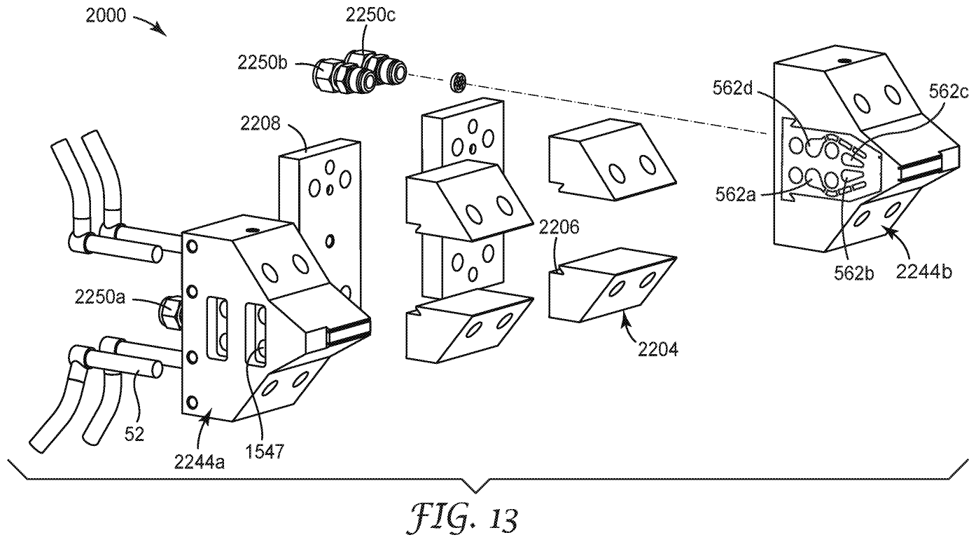

Shim 500 has several holes 547 to allow the passage of, for example, bolts, to hold shim 500 and others to be described below into an assembly. Shim 500 also has dispensing surface 567, and in this embodiment, dispensing surthce 567 has indexing groove 580 which can receive an appropriately shaped key to ease assembling diverse shims into a die. The shim may also have identification notch 582. to help verify that the die has been assembled in the desired mariner. This embodiment has shoulders 590 and 592 which can assist in mounting the assembled die with a mount of the type shown in FIG. 13. Shim 500 has dispensing opening 556, but it will be noted that this shim has no connection between dispensing opening 556 and any of cavities 562a, 562b, 562c, or 562d. Shim 500 serves as a spacer shim and provides a sidewall for passageways of adjacent shims. Opening 556 provides a continuous dispensing slot for extrusion. This continuous slot enables polymer streams to merge together to form demarcation lines in the coextruded polymeric article between die orifices.

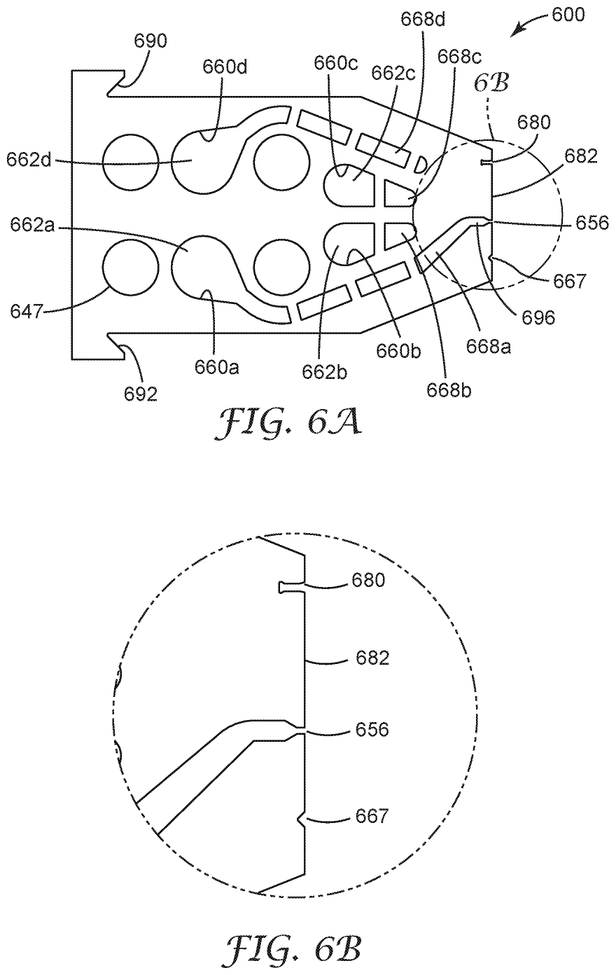

Referring to FIGS. 6A and 6B, a plan view of shim 600 is illustrated. Shim 600 has first aperture 660a, second aperture 660b, third aperture 660c, and fourth aperture 660d. When shim 600 is assembled with others as shown in FIGS. 10 and 11, aperture 660a aids in defining first cavity 662a, aperture 660b aids in defining second cavity 662b, aperture 660c aids in defining third cavity 662c, and aperture 660d aids in defining third cavity 662d. Passageways 668a, 668b, 668c, and 668d cooperate with analogous passageways on adjacent shims to allow passage from cavities 662a, 662b, 662c, and 662d to the dispensing surfaces of the appropriate shims when the shims are assembled as shown in FIGS. 10 and 11.

Shim 600 has several holes 647 to allow the passage of, for example, bolts, to hold shim 600 and others to be described below into an assembly. Shim 600 also has dispensing surface 667, and in this embodiment, dispensing surface 667 has indexing groove 680 which can receive an appropriately shaped key to ease assembling diverse shims into a die. The shim may also have identification notch 682 to help verify that the die has been assembled in the desired manner. This embodiment has shoulders 690 and 692 which can assist in mounting the assembled die with a mount of the type shown in FIG. 13. Shim 600 has dispensing opening 656, in dispensing surface 667. Dispensing opening 656 may be more clearly seen in the expanded view shown in FIG. 6B. It might seem that there is no path from cavity 662a to dispensing opening 656, via, for example, passageway 668a, but the flow has a route in the perpendicular-to-the-plane-of-the-drawing dimension when the sequence of FIG. 6 is completely assembled.

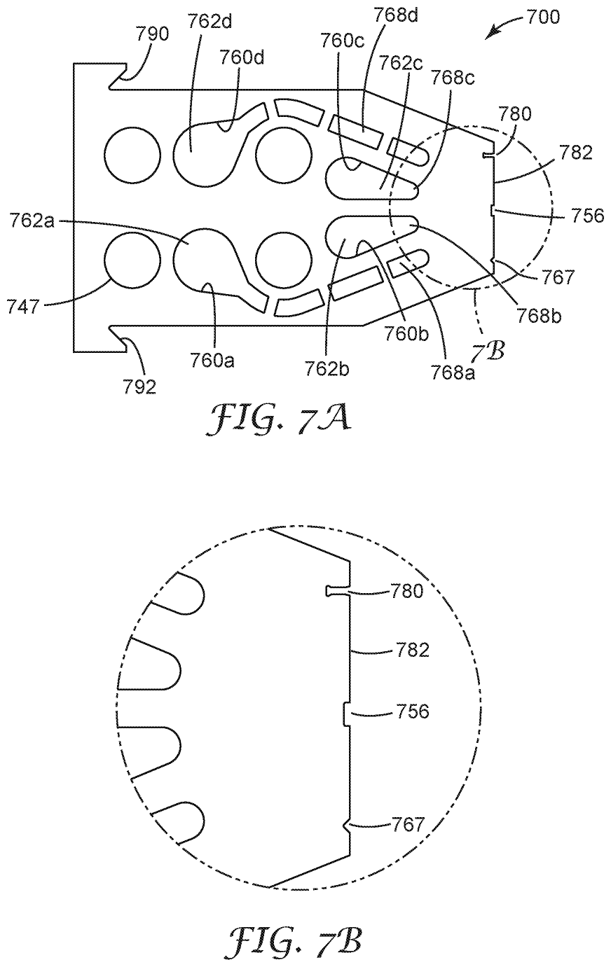

Referring to FIGS. 7A and 7B, a plan view of shim 700 is illustrated. Shim 700 has first aperture 760a, second aperture 760b, third aperture 760c, and fourth aperture 760d. When shim 700 is assembled with others as shown in FIGS. 10 and 11, aperture 760a aids in defining first cavity 762a, aperture 760b aids in defining second cavity 762b, aperture 760c aids in defining third cavity 762c, and aperture 760d aids in defining third cavity 762d. Passageways 768a, 768b, 768c, and 768d cooperate with analogous passageways on adjacent shims to allow passage from cavities 762a, 762b, 762c, and 762d to the dispensing surfaces of the appropriate shims when the shims are assembled as shown in FIGS. 10 and 11.

Shim 700 has several holes 747 to allow the passage of, for example, bolts, to hold shim 700 and others to be described below into an assembly. Shim 700 also has dispensing surface 767, and in this embodiment, dispensing surface 767 has indexing groove 780 which can receive an appropriately shaped key to ease assembling diverse shims into a die. The shim may also have identification notch 782 to help verify that the die has been assembled in the desired manner. This embodiment has shoulders 790 and 792 which can assist in mounting the assembled die with a mount of the type shown in FIG. 13.

Shim 700 has dispensing opening 756, but it will be noted that this shim has no connection between dispensing opening 756 and any of the cavities 762a, 762b, 762c, or 762d. Shim 700 is a spacer shim and provides a sidewall for passageways of adjacent shims. Opening 756 provides a continuous dispensing slot for extrusion. This continuous slot enables polymers streams to merge together to form demarcation lines in the coextruded polymeric article between die orifices.

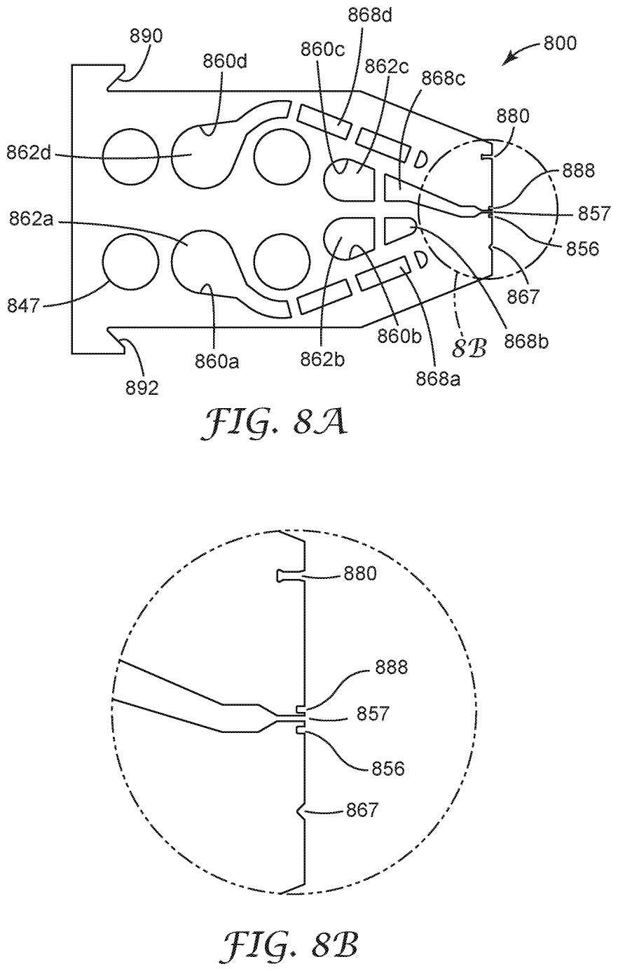

Referring to FIGS. 8A and 8B, a plan view of shim 800 is illustrated. Shim 800 has first aperture 860a, second aperture 860b, third aperture 860c, and fourth aperture 860d. When shim 800 is assembled with others as shown in FIGS. 10 and 11, aperture 860a aids in defining first cavity 862a, aperture 860b aids in defining second cavity 862b, aperture 860c aids in defining third cavity 862c, and aperture 860d aids in defining third cavity 862d. Passageways 868a, 868b, 868c, and 868d cooperate with analogous passageways on adjacent shims to allow passage from cavities 862a, 862b, 862c, and 862d to the dispensing surfaces of the appropriate shims when the shims are assembled as shown in FIGS. 10 and 11.

Shim 800 has several holes 847 to allow the passage of, for example, bolts, to hold shim 800 and others to be described below into an assembly. Shim 800 also has dispensing surface 867, and in this embodiment, dispensing surface 867 has indexing groove 880 which can receive an appropriately shaped key to ease assembling diverse shims into a die. The shim may also have identification notch 882 to help verify that the die has been assembled in the desired manner. This embodiment has shoulders 890 and 892 which can assist in mounting the assembled die with a mount of the type shown in FIG. 13. Shim 800 has dispensing opening 857, in dispensing surface 867. Dispensing opening 857 may be more clearly seen in the expanded view shown in FIG. 8B. It might seem that there is no path from cavity 862c to dispensing opening 857, via, for example, passageway 868c, but the flow has a route in the perpendicular-to-the-plane-of-the-drawing dimension when the sequence of FIG. 8 is completely assembled. Shim 800 also has dispensing opening 858 and 856, but it will be noted that these openings have no connection between dispensing opening 858 and 856 and any of cavities 862a, 862b, 862c, or 862d. Opening 858 provides an expanded dispensing slot for the distal end of the projection. This is to minimize the effect of reduced flow that is generally seen at the end of a dispensing slot such as this. Opening 856 provides a continuous dispensing slot between the first and second orifices for extrusion and enables demarcation lines within the coextruded polymeric article.

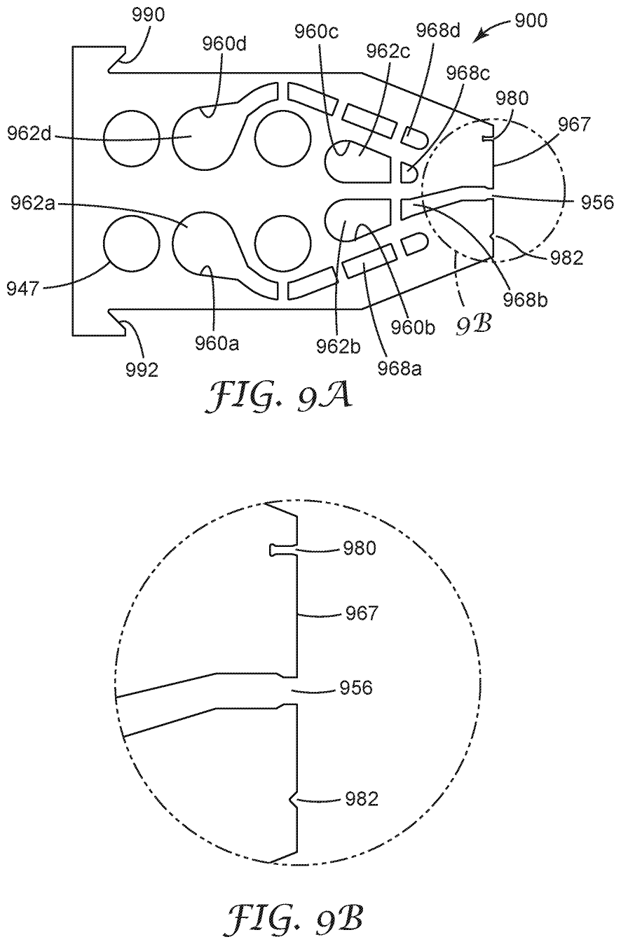

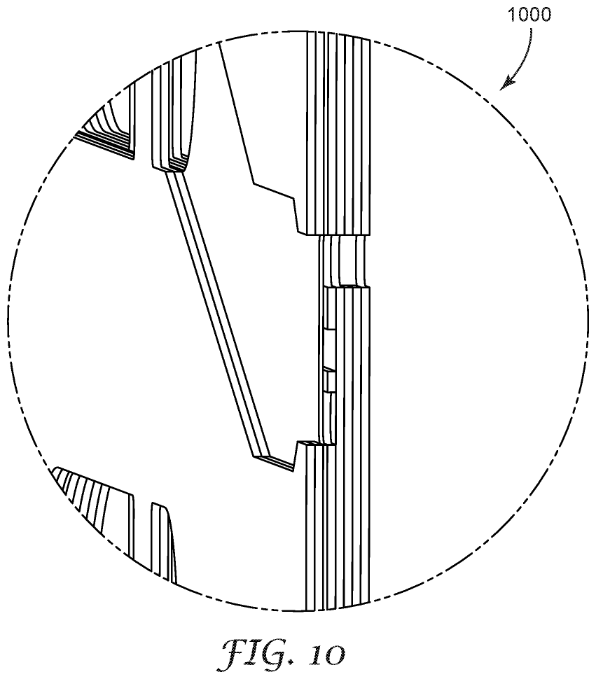

Referring to FIGS. 9A and 9B, a plan view of shim 900 is illustrated. Shim 900 has first aperture 960a, second aperture 960b, third aperture 960c, and fourth aperture 960d. When shim 900 is assembled with others as shown in FIGS. 10 and 11, aperture 960a aids in defining first cavity 962a, aperture 960b aids in defining second cavity 962b, aperture 960c aids in defining third cavity 962c, and aperture 960d aids in defining third cavity 962d. Passageways 968a, 968b, 968c, and 968d cooperate with analogous passageways on adjacent shims to allow passage from cavities 962a, 962b, 962c, and 962d to the dispensing surfaces of the appropriate shims when the shims are assembled as shown in FIGS. 10 and 11.

Shim 900 has several holes 947 to allow the passage of, for example, bolts, to hold shim 900 and others to be described below into an assembly. Shim 900 also has dispensing surface 967, and in this embodiment, dispensing surface 967 has indexing groove 980 which can receive an appropriately shaped key to ease assembling diverse shims into a die. The shim may also have identification notch 982 to help verify that the die has been assembled in the desired manner. This embodiment has shoulders 990 and 992 which can assist in mounting the assembled die with a mount of the type shown in FIG. 13. Shim 900 has dispensing opening 956, in dispensing surface 967. Dispensing opening 956 may be more clearly seen in the expanded view shown in FIG. 9B. It might seem that there is no path from cavity 962b to dispensing opening 956, via, for example, passageway 968b, but the flow has a route in the perpendicular-to-the-plane-of-the-drawing dimension when the sequence of FIG. 9 is completely assembled.

Referring to FIG. 10, a perspective assembly drawing of a several different repeating sequences of shims, collectively 1000, employing the shims of FIGS. 5-9 to produce coextruded polymeric article 100 shown in FIG. 1, and coextruded polymeric article 200 shown in FIG. 2, is shown. It should be noted in FIG. 10 that the dispensing slot, formed by dispensing openings 556, 656, 756, 856, and 956 collectively in the plurality of shims, is a continuous opening across the die. This continuous opening is fed from the three extrusion orifices as shown in FIG. 3. There are no shims without dispensing openings, which may form breaks to cause the extruded polymeric compositions to form into separated strands.

Referring to FIG. 11, an exploded perspective assembly drawing of a repeating sequence of shims employing the shims of FIGS. 5-9 is illustrated. In the illustrated embodiment, the repeating sequence includes, from bottom to top as the drawing is oriented, one instance of shim 500, two instances of shim 600, which forms the first orifice, one instance of shim 500, one instance of shim 800, which forms the third orifice, one instance of shim 700, and two instances of shim 900, which forms the second orifice. In this view, it can be appreciated how the three orifices are merged together at the extrusion slot to generate a continuous a coextruded polymeric article.

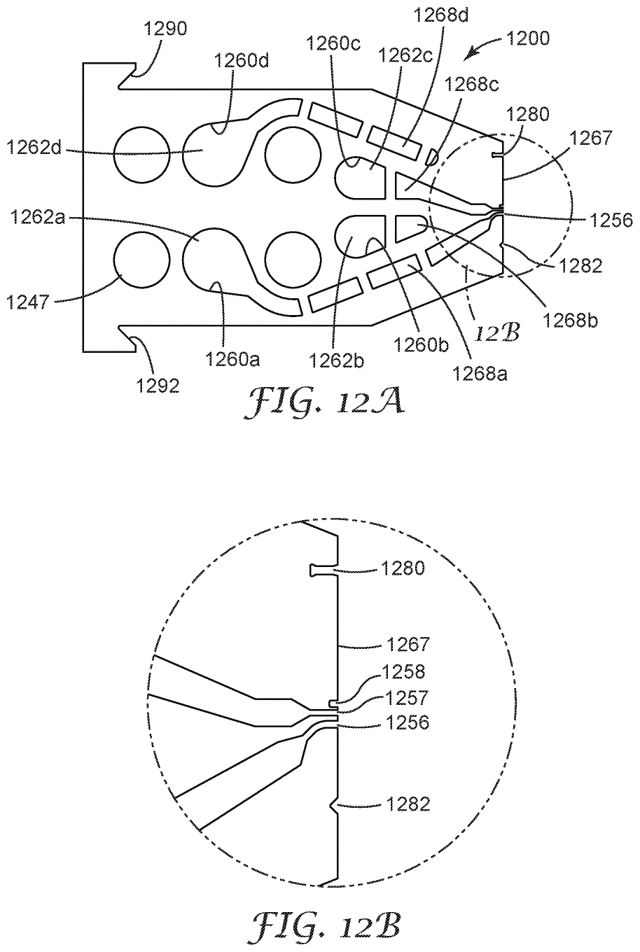

Referring to FIGS. 12A and 12B, a plan view of shim 1200 is illustrated. Shim 1200 has first aperture 1260a, second aperture 1260b, third aperture 1260c, and fourth aperture 1260d. When shim 1200 is assembled with others, aperture 1260a aids in defining first cavity 1262a, aperture 1260b aids in defining second cavity 1262b, aperture 1260c aids in defining third cavity 1262c, and aperture 1260d aids in defining third cavity 1262d. Passageways 1268a, 1268b, 1268c, and 1268d cooperate with analogous passageways on adjacent shims to allow passage from cavities 1262a, 1262b, 1262c, and 1262d to the dispensing surfaces of the appropriate shims.

Shim 1200 has several holes 1247 to allow the passage of, for example, bolts, to hold shim 1200 and others to be described below into an assembly. Shim 1200 also has dispensing surface 1267, and in this embodiment, dispensing surface 1267 has indexing groove 1280, which can receive an appropriately shaped key to ease assembling diverse shims into a die. The shim may also have identification notch 1282 to help verify that the die has been assembled in the desired manner. This embodiment has shoulders 1290 and 1292, which can assist in mounting the assembled die with a mount of the type shown in FIG. 13. Shim 1200 has dispensing opening 1256, and dispensing opening 1257, and also dispensing opening 1258 in dispensing surface 1267. Dispensing openings 1256 and 1258 may be more clearly seen in the expanded view shown in FIG. 12B. It might seem that there is no path from cavity 1262c to dispensing opening 1257, and also 1262a to dispensing opening 1256, via, for example, passageway 1268a and 1268c, but the flow has a route in the perpendicular-to-the-plane-of-the-drawing dimension when the sequence of FIG. 12 is completely assembled. Shim 1200 is useful to generate dispensing orifices as shown in FIG. 4. Opening 1258 has no connection to the cavities. Opening 1258 provides an expanded dispensing slot for the distal end of the projection. This is to minimize the effect of reduced flow that is generally seen at the end of a dispensing slot such as this.

Shim 1200 is an alternate to shim 800. A die stack with a sequence of shims 500, 600, 600, 500, 1200, 700, 900, 900 generates the orifice configuration shown in FIG. 4. A die stack with a sequence of shims 500, 600, 600, 500, 800, 700, 900, 900 generates the orifice configuration shown in FIG. 3.

Referring to FIG. 13, an exploded perspective view of a mount 2000 suitable for an extrusion die composed of multiple repeats of the repeating sequence of shims of FIGS. 10 and 11 is illustrated. Mount 2000 is particularly adapted to use shims 500, 600, 700, 800, and 900 or shims 500, 600, 700, 1200, and 900, as shown in FIGS. 5-9 and 12. For visual clarity, however, only a single instance of shims is shown in FIG. 13. The multiple repeats of the repeating sequence of shims of FIGS. 10 and 11 are compressed between two end blocks 2244a and 2244b. Conveniently, through bolts can be used to assemble the shims to end blocks 2244a and 2244b, passing through holes 547 in shims 500 et al.

In this embodiment, inlet fittings provide a flow path for three streams of molten polymer through end blocks 2244a and 2244b to cavities 562a, 562b, and 562c, and 562d. Compression blocks 2204 have notch 2206 that conveniently engages the shoulders on shims (e.g., 590 and 592) on 500. When mount 2230 is completely assembled, compression blocks 2204 are attached by, for example, machine bolts to backplates 2208. Holes are conveniently provided in the assembly for the insertion of cartridge heaters 52.

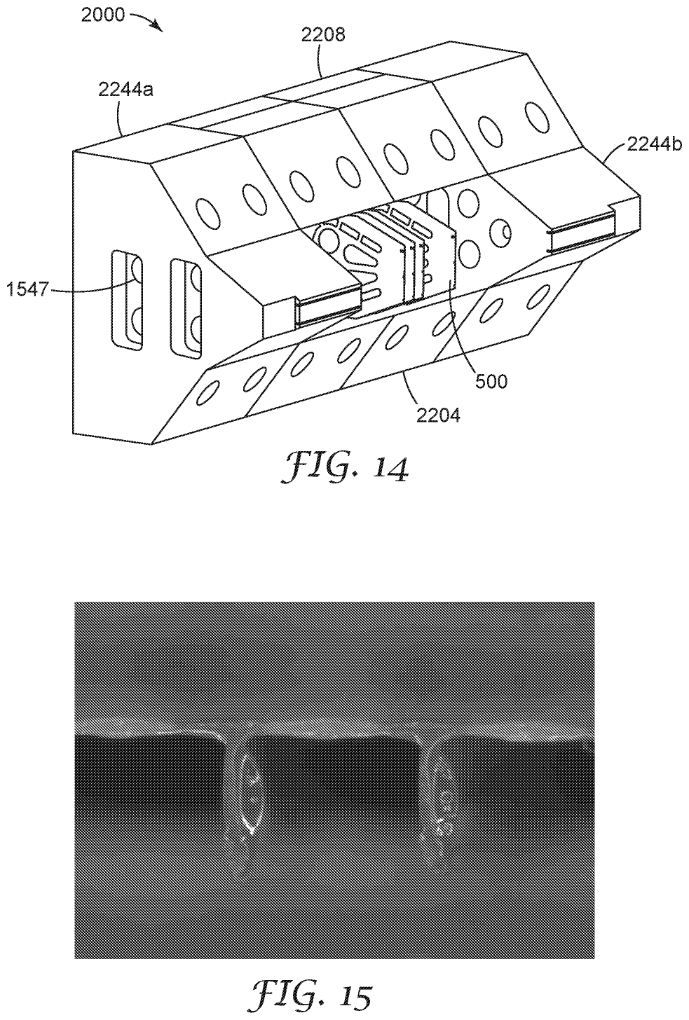

Referring to FIG. 14, a perspective view of the mount 2000 of FIG. 13 is illustrated in a partially assembled state. A few shims, for example, 500 are in their assembled positions to show how they fit within mount 2000, but most of the shims that would make up an assembled die have been omitted for visual clarity.

In some embodiments, at least one of the first, second, or third adhesive of the second coextruded polymeric article described herein are independently at least one of, including copolymers and blends thereof, an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.

In some embodiments, the first and second materials of the second coextruded polymeric article described herein are the same. In some embodiments, the first and third materials of the second coextruded polymeric article described herein are the same.

In some embodiments, there are at least 5 (in some embodiments, at least 10, 15, 20, 25, 30, 35, or even up to 40) projections per cm.

In some embodiments, the projections of a coextruded polymeric article described herein are generally parallel to each other and generally perpendicular to the first major surface.

In some embodiments, the projections have a surface contacting the protrusion associated with a projection, wherein said surface is planar. In some embodiments, the projections have a surface contacting the protrusion associated with a projection, wherein said surface exhibits at least one depression. In some embodiments, the projections have a surface contacting the protrusion associated with a projection, wherein said surface exhibits at least one obtrusion.

In some embodiments, the projections of a coextruded polymeric article described herein have an aspect ratio (i.e., height to thickness) of at least 2:1 (in some embodiments, at least 3:1, or even at least 4:1).

In some embodiments, the projection of a coextruded polymeric article described herein are spaced apart not more than 2 mm (in some embodiments, not more than 1 mm).

In some embodiments, the projections of a coextruded polymeric article described herein have a height and thickness and the thickness is along the length of each respective projections.

In some embodiments, the protrusions a coextruded polymeric article described herein do not contact the first major surface.

In some embodiments, the height of the protrusions of a coextruded polymeric article described herein are in a range from 0.1 mm to 5 mm (in some embodiments, in a range from 0.1 mm to 2 mm, or even 0.1 mm to 1 mm).

In some embodiments, the protrusions of a coextruded polymeric article described herein have a longest cross-sectional dimension in the direction normal to the projections in a range from 0.05 mm to 0.5 mm (in some embodiments, in a range from 0.05 mm to 0.2 mm, or even 0.05 mm to 0.1 mm).

In some embodiments, regions of a coextruded polymeric article described herein have a distance between protrusions in a range from 0.25 mm to 5 mm (in some embodiments, in a range from 0.25 mm to 2 mm, or even 0.25 mm to 1 mm).

In some embodiments of a coextruded polymeric article described herein, there is a distance between the first and second major surfaces are in a range from 0.05 mm to 5 mm (in some embodiments, in a range from 0.05 mm to 3 mm, 0.05 mm to 2 mm, or even 0.1 mm to 1 mm).

In some embodiments, the extension of the protrusion of a coextruded polymeric article described herein is from not more than to the first major surface to less than the height of the protrusion (in some embodiments, in a range from 1% of the protrusion length to 75% of the protrusion length, 1% of the projection length to 50% of the protrusion length, or even 10% of the protrusion length to 50% of the protrusion length).

One exemplary use for articles described herein is as a coextruded polymeric adhesive article, wherein an adhesive is initially not exposed to contact to a substrate brought into proximity of the article, and can subsequently be exposed to contact to the substrate after mechanical movement of the projections of the article, such as through hand-pressure in a shearing mode.

In some embodiments, polymeric materials used to make coextruded polymeric articles described herein may comprise a colorant (e.g., pigment and/or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for one or more of the polymeric materials. The amount of colorant(s) to be used in specific embodiments can be readily determined by those skilled in the art (e.g., to achieve desired color, tone, opacity, transmissivity, etc.). If desired, the polymeric materials may be formulated to have the same or different colors.

Another exemplary use for coextruded polymeric articles described herein is as a household cleaning product (e.g., a mop, a duster, a brush, a cleaning cloth, or a lint roller) whose effectiveness is increased by the movement inherent to its use.

Another exemplary use for coextruded polymeric articles described herein is as an adhesive article that can be adhesively attached to a substrate by slight shearing motion (e.g., a wall attachment which can be positioned without any adhesion), and subsequently adhered to the wall by gentle hand pressure accompanied by a slight shearing movement. The wall attachment can be subsequently removable by peeling. Another exemplary coextruded polymeric adhesive article has two levels of adhesiveness, which can be applied to a substrate at a low level of adhesiveness, repositioned as needed, and then subsequently be made to be highly adhesive by applying gentle hand pressure accompanied by a slight shearing movement. Yet another exemplary coextruded polymeric adhesive article has three levels of adhesiveness and two-sided adhesiveness. Such coextruded polymeric articles can behave as any described above, and then, on the still exposed surface (the surface opposing the surface already adhered to a substrate) can exhibit adhesiveness with respect to an additional substrate or article. For example, the coextruded polymeric article can be positioned against a wall, repositioned freely in a state of no or little adhesiveness. A gentle hand pressure can be applied accompanied with a slight shearing movement to provide a high level of adhesiveness. Then use of a third level of adhesiveness existing on the side of the coextruded polymeric adhesive article opposite the side adhered to the wall (which may be the same or different from either of the first two levels of adhesiveness) can be made to affix other objects to the wall such as posters, handbills, and other decorative materials, either permanently or removably, either once or repeatedly.

It is also within the scope of the present disclosure that properties in addition to adhesiveness can be triggered to exhibit tiered behavior in embodiments of coextruded polymeric articles described herein. For example, various chemical properties can also be utilized to provide channeling webs or tapes. An exemplary coextruded polymeric article could have hydrophobic projections and hydrophilic protrusions.

Water, for instance, gently encountering such a coextruded polymeric article from the side having the projections would bead-up on the coextruded polymeric article, unless it approached with a determinate level of force or pressure, whereupon it would penetrate between projections deeply enough to encounter hydrophilic protrusions, and would be wicked down-channel due to hydrostatic forces, while still unable to penetrate through the layer to any appreciable extent.

### Exemplary Embodiments

1A. A coextruded polymeric article comprising first and second opposed major surfaces, wherein a plurality of projections extend from only the first major surface (i.e., the second major surface is free of any projections), wherein each projection has at least first and second opposed sides and a height from the first major surface to a distal end, wherein at least a majority by number (i.e., at least 50 percent by number; in some embodiments, at least 55, 60, 65, 70, 75, 80, 85, 90, 95, or even 100 percent) of the projections have a protrusion extending from only the first side and extending in one direction not more than to the first major surface and extending in an opposite direction to less than the height of the respective projection (i.e., less than to the distal end of the respective protrusion), wherein the projections extend to the second major surface, wherein there are regions extending from the first and second major surfaces that are between projections, wherein the regions comprise a first material, the projections comprise a second material, and the protrusions comprise a third material, wherein the second and third materials are different, and wherein at least one of the second or third materials comprise adhesives.
2A. The coextruded polymeric article of Exemplary Embodiment lA having a (machine direction) length of at least 5 mm (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m).
3A. The coextruded polymeric article of Exemplary Embodiment 2A, wherein the protrusions and projections extend along the length of the coextruded polymeric article (i.e., have respective lengths of at least 5 mm (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m)).
4A. The coextruded polymeric article of any preceding A Exemplary Embodiment, wherein there is a demarcation line between connected projections and adjacent protrusions.
5A. The coextruded polymeric article of any preceding A Exemplary Embodiment, wherein there is a demarcation line between connected projections and adjacent protrusions connected regions and projections.
6A. The coextruded polymeric article of any preceding A Exemplary Embodiment, wherein the projections are generally parallel to each other and generally perpendicular to the first major surface.
7A. The coextruded polymeric article of any preceding A Exemplary Embodiment, wherein the projections have an aspect ratio (i.e., height to thickness) of at least 2:1 (in some embodiments, at least 3:1, or even at least 4:1).
8A. The coextruded polymeric article of any preceding A Exemplary Embodiment, wherein the projections are spaced apart not more than 2 mm (in some embodiments, not more than 1 mm).
9A. The coextruded polymeric article of any preceding A Exemplary Embodiment, wherein the projections have a height and thickness and the thickness is along the length of each respective projections.
10A. The coextruded polymeric article of any preceding A Exemplary Embodiment, wherein the first and second materials are the same.
11A. The coextruded polymeric article of any of Exemplary Embodiments 1A to 9A, wherein the first and second materials are different.
12A. The coextruded polymeric article of any preceding A Exemplary Embodiment, wherein the first and third materials are the same.
13A. The coextruded polymeric article of any of Exemplary Embodiments 1A to 11A, wherein the first and third materials are different.
14A. The coextruded polymeric article of any preceding A Exemplary Embodiment, wherein the first material comprises a first adhesive.
15A. The coextruded polymeric article of Exemplary Embodiment 14A, wherein the first adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.
16A. The coextruded polymeric article of any preceding A Exemplary Embodiment, wherein the second material comprises a second adhesive.
17A. The coextruded polymeric article of Exemplary Embodiment 16A, wherein the second adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.
18A. The coextruded polymeric article of any preceding A Exemplary Embodiment, wherein the third material comprises a third adhesive.
19A. The coextruded polymeric article of any preceding A Exemplary Embodiment, wherein the protrusions do not contact the first surface.
20A. The coextruded polymeric article of any preceding A Exemplary Embodiment, wherein the height of the protrusions is in a range from 0.1 mm to 5 mm (in some embodiments, in a range from 0.1 mm to 2 mm, or even 0.1 mm to 1 mm).
21A. The coextruded polymeric article of any preceding A Exemplary Embodiment, wherein the protrusions have a longest cross-sectional dimension in a range from 0.05 mm to 0.5 mm (in some embodiments, in a range from 0.05 mm to 0.2 mm, or even 0.05 mm to 0.1 mm).
22A. The coextruded polymeric article of any preceding A Exemplary Embodiment, wherein regions have a distance between protrusions in a range from 0.25 mm to 5 mm (in some embodiments, in a range from 0.25 mm to 2 mm, or even 0.25 mm to 1 mm).
23A. The coextruded polymeric article of any preceding A Exemplary Embodiment having a distance between the first and second major surfaces are in a range from 0.05 mm to 5 mm (in some embodiments, in a range from 0.05 mm to 3 mm, 0.05 mm to 2 mm, or even 0.1 mm to 1 mm).
24A. The coextruded polymeric article of any preceding A Exemplary Embodiment, wherein the extension of the protrusion is from not more than to the first major surface to less than the height of the protrusion (in some embodiments, in a range from 1% of the protrusion length to 75% of the protrusion length, 1% of the projection length to 50% of the protrusion length, or even 10% of the protrusion length to 50% of the protrusion length).
25A. The coextruded polymeric article of any preceding A Exemplary Embodiment, wherein the projections have a surface contacting the protrusion associated with a projection, wherein said surface is planar.
26A. The coextruded polymeric article of any of Exemplary Embodiments 1A to 24A, wherein the projections have a surface contacting the protrusion associated with a projection, wherein said surface exhibits at least one depression.
27A. The coextruded polymeric article of any of Exemplary Embodiments 1A to 24A, wherein the projections have a surface contacting the protrusion associated with a projection, wherein said surface exhibits at least one obtrusion.
28A. The coextruded polymeric article of any preceding A Exemplary Embodiment, wherein there are at least 5 (in some embodiments, at least 10, 15, 20, 25, 30, 35, or even up to 40) projections per cm.
1B. A method of making a coextruded polymeric article of any preceding A Exemplary Embodiment, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;

extruding a layer from the distal opening of the die slot; and quenching the extruded layer.
1C. A method of making a coextruded polymeric article of any preceding A Exemplary Embodiment, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;

extruding a layer from the distal opening of the die slot; and quenching the extruded layer.
1D. A coextruded polymeric article comprising first and second opposed major surfaces, wherein a plurality of projections extend from only the first major surface (i.e., the second major surface is free of any projections), wherein each projection has at least first and second opposed sides and a height from the first major surface to a distal end, wherein at least a majority by number (i.e., at least 50 percent by number; in some embodiments, at least 55, 60, 65, 70, 75, 80, 85, 90, 95, or even 100 percent) of the projections have a protrusion extending from only the first side and extending in one direction not more than to the first major surface and extending in an opposite direction to less than the height of the respective projection (i.e., less than to the distal end of the respective protrusion), wherein the projections extend to the second major surface, wherein there are regions extending between the first and second major surfaces that are between projections, wherein the regions comprise a first material, the projections comprise a second material, and the protrusions comprise a third material, wherein at least two of the first, second, or third materials are different, and wherein the first, second, and third materials each comprise an adhesive.
2D. The coextruded polymeric article of Exemplary Embodiment 1D having a (machine direction) length of at least 5 mm (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m).
3D. The coextruded polymeric article of Exemplary Embodiment 2D, wherein the protrusions and projections extend along the length of the coextruded polymeric article (i.e., have respective lengths of at least 5 mm (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m)).
4D. The coextruded polymeric article of any preceding D Exemplary Embodiment, wherein there is a demarcation line between connected projections and adjacent protrusions.
5D. The coextruded polymeric article of any preceding D Exemplary Embodiment, wherein there is a demarcation line between connected projections and adjacent protrusions connected regions and projections.
6D. The coextruded polymeric article of any preceding D Exemplary Embodiment, wherein the first and second materials are the same.
7D. The coextruded polymeric article of any preceding D Exemplary Embodiment, wherein the first and third materials are the same.
8D. The coextruded polymeric article of any preceding D Exemplary Embodiment, wherein the first adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.
9D. The coextruded polymeric article of any preceding D Exemplary Embodiment, wherein the second adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.
10D. The coextruded polymeric article of any preceding D Exemplary Embodiment, wherein the third adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.
11D. The coextruded polymeric article of any preceding D Exemplary Embodiment, wherein the protrusions do not contact the first surface.
12D. The coextruded polymeric article of any preceding D Exemplary Embodiment, wherein the height of the protrusions is in a range from 0.1 mm to 5 mm (in some embodiments, in a range from 0.1 mm to 2 mm, or even 0.1 mm to 1 mm).
13D. The coextruded polymeric article of any preceding D Exemplary Embodiment, wherein the protrusions have a longest cross-sectional dimension in a range from 0.05 mm to 0.5 mm (in some embodiments, in a range from 0.05 mm to 0.2 mm, or even 0.05 mm to 0.1 mm).
14D. The coextruded polymeric article of any preceding D Exemplary Embodiment, wherein regions have a distance between protrusions in a range from 0.25 mm to 5 mm (in some embodiments, in a range from 0.25 mm to 2 mm, or even 0.25 mm to 1 mm).
15D. The coextruded polymeric article of any preceding D Exemplary Embodiment having a distance between the first and second major surfaces are in a range from 0.05 mm to 5 mm (in some embodiments, in a range from 0.05 mm to 3 mm, 0.05 mm to 2 mm, or even 0.1 mm to 1 mm).
16D. The coextruded polymeric article of any preceding D Exemplary Embodiment, wherein the extension of the protrusion is from not more than to the first major surface to less than the height of the protrusion (in some embodiments, in a range from 1% of the protrusion length to 75% of the protrusion length, 1% of the projection length to 50% of the protrusion length, or even 10% of the protrusion length to 50% of the protrusion length).
17D. The coextruded polymeric article of any preceding D Exemplary Embodiment, wherein the projections have a surface contacting the protrusion associated with a projection, wherein said surface is planar.
18D. The coextruded polymeric article of any of Exemplary Embodiments 1D to 16D, wherein the projections have a surface contacting the protrusion associated with a projection, wherein said surface exhibits at least one depression.
19D. The coextruded polymeric article of any of Exemplary Embodiments 1D to 16D, wherein the projections have a surface contacting the protrusion associated with a projection, wherein said surface exhibits at least one obtrusion.
20D. The coextruded polymeric article of any preceding D Exemplary Embodiment, wherein there are at least 5 (in some embodiments, at least 10, 15, 20, 25, 30, 35, or even up to 40) projections per cm.
1E. A method of making a coextruded polymeric article of any preceding D Exemplary Embodiment, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;

extruding a layer from the distal opening of the die slot; and quenching the extruded layer.
1F. A method of making a coextruded polymeric article of any preceding D Exemplary Embodiment, the method comprising:

providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;

providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;

extruding a layer from the distal opening of the die slot; and

quenching the extruded layer.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLE 1

A co-extrusion die as generally depicted in FIGS. 13 and 14 was assembled with a multi shim repeating pattern of extrusion orifices as generally illustrated in FIG. 3. The thickness of the shims in the repeat sequence was 4 mils (0.102 mm) for shims 600, 800, and 900 and 2 mils (0.51 mm) for shim 500 and 700. These shims were formed from stainless steel, with perforations cut by a wire electron discharge machining. The shims were stacked in a repeating sequence 500, 600, 600, 500, 800, 700, 900, and 900. The extrusion orifices were aligned in a collinear, alternating arrangement. The total width of the shim setup was about 12.5 cm. (5 inches).

The inlet fittings on the two end blocks were each connected to three conventional single-screw extruders. The extruders feeding two cavities were loaded with polyethylene copolymer (obtained under the trade designation “ELVALOY 1609” from DuPont Company, Wilmington, Del.). The polypropylene for the first cavity was dry blended with 3% yellow color concentrate (obtained under the trade designation “10038103” from PolyOne Distribution, Romeoville, Ill.). The polypropylene for the second cavity was dry blended with 3% green color concentrate (obtained under the trade designation “PP64643536” from Clariant, Minneapolis, Minn.). The extruder feeding the third cavity was loaded with acrylate copolymer adhesive (obtained under the trade designation “R 55586” from 3M Company, St. Paul, Minn.). The 4^{th} cavity was not used.

The melt was extruded vertically into an extrusion quench takeaway. The quench roll was a smooth temperature controlled chrome plated 20 cm diameter steel roll. The quench temperature was controlled with internal water flow. The web path wrapped 180 degrees around the chrome steel roll and then to a windup roll.

Other process conditions are listed below:

| | |
|---|---|
| Flow rate of first polymer (base) | 0.7 kg/hr. |
| Flow rate of second polymer (ribbon) | 1.1 kg/hr. |
| Flow rate of third polymer (adhesive) | 0.5 kg/hr. |
| Extrusion temperature | 190° C. |
| Quench roll temperature | 10° C. |
| Quench takeaway speed | 1.3 m/min. |

An optical microscope was used to measure the film profile resulting in the following measurements:

| | |
|---|---|
| Overall film caliber | 711 micrometers |
| Ribbon repeat length | 914 micrometers |
| Base thickness | 76 micrometers |
| Adhesive thickness | 76 micrometers |

An optical image of the resulting article is shown in FIG. 15.

Foreseeable modifications and alterations of this disclosure will be apparent to those skilled in the art without departing from the scope and spirit of this invention. This invention should not be restricted to the embodiments that are set forth in this application for illustrative purposes.

1. A coextruded polymeric article comprising first and second opposed major surfaces, wherein a plurality of projections extend from only the first major surface, wherein each projection has at least first and second opposed sides and a height from the first major surface to a distal end, wherein at least a majority by number of the projections have a protrusion extending from only the first side and extending in one direction not more than to the first major surface and extending in an opposite direction to less than the height of the respective projection, wherein the projections extend to the second major surface, wherein there are regions extending from the first and second major surfaces that are between projections, wherein the regions comprise a first material, the projections comprise a second material, and the protrusions comprise a third material, wherein the second and third materials are different, and wherein at least one of the second or third materials comprise adhesives.

2. The coextruded polymeric article of claim 1 having a length of at least 5 millimeters.

3. The coextruded polymeric article of claim 2, wherein the protrusions and projections extend along the length of the coextruded polymeric article.

4. The coextruded polymeric article of claim 1, wherein there is a demarcation line between connected projections and adjacent protrusions.

5. The coextruded polymeric article of claim 1, wherein there is a demarcation line between connected projections and adjacent protrusions connected regions and projections.

6. The coextruded polymeric article of claim 1, wherein the projections are generally parallel to each other and generally perpendicular to the first major surface.

7. The coextruded polymeric article of claim 1, wherein the projections have an aspect ratio of at least 2 to 1.

8. The coextruded polymeric article of claim 1, wherein the protrusions do not contact the first surface.

9. A method of making a coextruded polymeric article of claim 1, the method comprising:
providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;
providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;
extruding a layer from the distal opening of the die slot; and
quenching the extruded layer.

10. A method of making a coextruded polymeric article of 8 claim 1, the method comprising:
providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;
providing via extrusion a first material to the first cavity of the extrusion die, a second material to the second cavity of the extrusion die, and a third material to the third cavity of the extrusion die, wherein the second and third materials are different, and wherein at least one of the second material and the third material comprises an adhesive;
extruding a layer from the distal opening of the die slot; and
quenching the extruded layer.

11. A coextruded polymeric article comprising first and second opposed major surfaces, wherein a plurality of projections extend from only the first major , wherein each projection has at least first and second opposed sides and a height from the first major surface to a distal end, wherein at least a majority by number of the projections have a protrusion extending from only the first side and extending in one direction not more than to the first major surface and extending in an opposite direction to less than the height of the respective projection, wherein the projections extend to the second major surface, wherein there are regions the first and second major surfaces that are between projections, wherein the regions comprise a first material, the projections comprise a second material, and the protrusions comprise third material, wherein at least two of the first, second, or third materials are different, and wherein the first, second, or third materials each comprise an adhesive.

12. The coextruded polymeric article of claim 11 having a length of at least 5 millimeters.

13. The coextruded polymeric article of claim 12, wherein the protrusions and projections extend along the length of the coextruded polymeric article.

14. The coextruded polymeric article of 13 claim 11, wherein there is a demarcation line between connected projections and adjacent protrusions.

15. The coextruded polymeric article of 14 claim 11, wherein there is a demarcation line between connected projections and adjacent protrusions connected regions and projections.

16. The coextruded polymeric article of 15 claim 11, wherein the first and second materials are the same.

17. The coextruded polymeric article of 16 claim 11, wherein the protrusions do not contact the first surface.

18. The coextruded polymeric article of 17 claim 11, wherein the extension of the protrusion is from not more than to the first major surface to less than the height of the protrusion.

19. The coextruded polymeric article of 18 claim 11, wherein the projections have a surface contacting the protrusion associated with a projection, wherein said surface is planar.

20. A method of making a coextruded polymeric article of 19 claim 11, the method comprising:
providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims that together provide a fluid passageway between the first cavity and a first orifice and also together provide a fluid passageway between the third cavity and a third orifice, and a third plurality of shims that together provide a fluid passageway between the first cavity and a first orifice;
providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;
extruding a layer from the distal opening of the die slot; and
quenching the extruded layer.

21. A method of making a coextruded polymeric article of claim 11, the method comprising:
providing an extrusion die comprising a plurality of shims positioned adjacent to one another, the shims together defining a first cavity, a second cavity, a third cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the second cavity and a second orifice, a second plurality of a repeating sequence of shims provide a fluid passageway between the third cavity and a third orifice, and a third plurality of shims that together provide a fluid passageway between the first cavity and a first orifice;
providing via extrusion a first material to the first cavity of the extrusion die, a second material to the second cavity of the extrusion die, and a third material to the third cavity of the extrusion die, wherein at least two of the first, second, and third materials are different, and wherein each of the first material, the second material, and the third material comprises an adhesive;
extruding a layer from the distal opening of the die slot; and
quenching the extruded layer.
